(19) United States
(12) Patent Application Publication
(10) Pub. No.: US 2024/0051110 A1
(43) Pub. Date: Feb. 15, 2024

(54) Rotary Tool and Standby Base

(71) Applicant: TECHTRONIC CORDLESS GP, Anderson, SC (US)

(72) Inventors: Tsz Kin WONG, Hong Kong (CN); Man Kit MOK, Hong Kong (CN)

(21) Appl. No.: 18/366,055

(22) Filed: Aug. 7, 2023

Related U.S. Application Data
(60) Provisional application No. 63/397,755, filed on Aug. 12, 2022.

(51) Int. Cl. B25F 5/02

(52) U.S. Cl. CPC B25F 5/029

(57) ABSTRACT

A power tool system including a power tool and a base. The power tool has a housing, a motor, and a chuck. The housing supports or is connected to a power source. The motor is supported by and disposed in the housing and includes an output shaft. The motor is configured to drive rotation of the output shaft. The chuck is coupled to the output shaft for rotation with the output shaft. The chuck is configured to receive a tool bit configured to perform an operation. The base is engageable by the power tool. Positioning the power tool in alignment with the base or in engagement with the base is configured to stop rotation of the chuck.

### CROSS-REFERENCE TO RELATED APPLICATION

This application claims priority to U.S. Provisional Patent Application No. 63/397,755 filed on Aug. 12, 2022 (Atty. Docket No.: 206730-9096-US01), the entire contents of which are incorporated herein by reference.

### FIELD

The present disclosure relates to power tools, and more particularly, to rotary power tools.

### SUMMARY

The present disclosure provides, in one aspect, a power tool system including a power tool and a base. The power tool has a housing, a motor, and a chuck. The housing supports or is connected to a power source. The motor is supported by and disposed in the housing and includes an output shaft. The motor is configured to drive rotation of the output shaft. The chuck is coupled to the output shaft for rotation with the output shaft. The chuck is configured to receive a tool bit configured to perform an operation. The base is engageable by the power tool. Positioning the power tool in alignment with the base or in engagement with the base is configured to stop rotation of the chuck.

In another aspect, the disclosure provides a power tool including a housing, a motor, an actuator, and a chuck. The housing supports or is connected to a power source. The motor is supported by and disposed in the housing and includes an output shaft. The motor is configured to drive rotation of the output shaft. The actuator is on the housing and is actuatable to switch the power tool between an on mode in which the motor is configured to rotate the output shaft, and an off mode in which the motor does not rotate. The chuck is coupled to the output shaft for rotation with the output shaft. The chuck is configured to receive a tool bit configured to perform an operation. The power tool is switchable from the on mode to a standby mode in which rotation of the motor is stopped without actuation of the actuator.

In another aspect, the disclosure provides a power tool system including a power tool and a base. The power tool has a housing, a first component, a motor, and a chuck. The housing supports or is connected to a power source. The first component is supported by and disposed in the housing. The motor is supported by and disposed in the housing and includes an output shaft. The motor is configured to drive rotation of the output shaft. The chuck is coupled to the output shaft for rotation with the output shaft. The chuck is configured to receive a tool bit configured to perform an operation. The base includes a second component that is configured to engage the first component from a non-zero distance to stop rotation of the motor.

Other features and aspects of the invention will become apparent by consideration of the following detailed description and accompanying drawings.

### BRIEF DESCRIPTION OF THE DRAWINGS

FIG. 1 is a perspective view of a power tool system including a power tool and a base.

FIG. 2 is an exploded view of the power tool and the base.

FIG. 3 is a perspective view of a portion of the power tool.

FIG. 4 is a top view of the base.

FIG. 5 is a cross-sectional view of the power tool system taken along line 5-5 in FIG. 1.

FIG. 6 is a schematic view of a circuit for the power tool system in an open and a closed state.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

The detailed description uses numerical and letter designations to refer to features in the drawings Like or similar designations in the drawings and description have been used to refer to like or similar parts of the invention.

The singular forms “a,” “an,” and “the” include plural references unless the context clearly dictates otherwise. The terms “coupled,” “fixed,” and the like refer to both direct coupling or fixing, as well as indirect coupling or fixing through one or more intermediate components or features, unless otherwise specified herein. As used herein, the terms “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

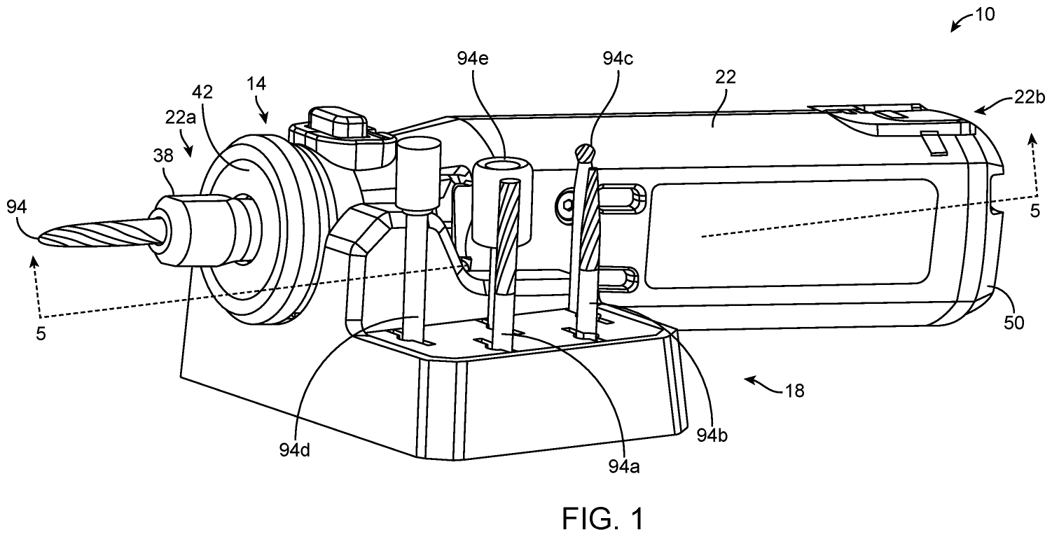

FIG. 1 illustrates a power tool system 10 including a power tool 14 and a base 18. In the illustrated embodiment, the power tool 14 is a rotary tool. As such, the power tool 14 may perform an operation such as, but not limited to, a screwdriving and/or drilling operation. The power tool 14 is switchable between an on mode and an off mode. The power tool 14 and the base 18 are selectively engageable to switch the power tool 14 to a standby mode. That is, positioning the power tool 14 in alignment with the base 18 or in engagement with the base 18 is configured to switch the power tool 14 to a standby mode, as will be described in further detail.

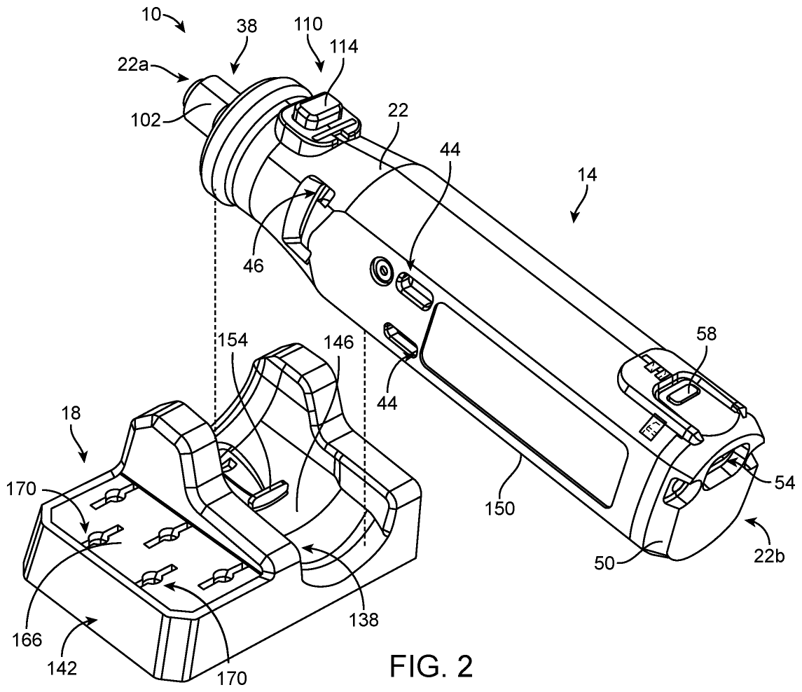

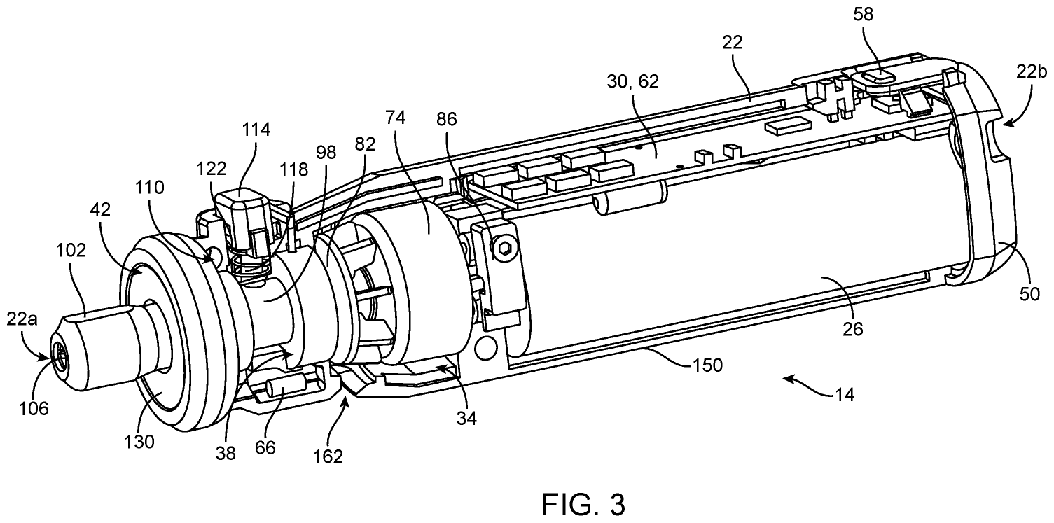

With reference to FIGS. 2 and 3, the power tool 14 includes a housing 22, a battery 26, a printed circuit board assembly (PCBA) 30, a drive assembly 34, a chuck 38, and a work light 42 (FIG. 1). Each of the battery 26, the PCBA 30, and the drive assembly 34 is supported by and disposed in the housing 22. The chuck 38 is partially received in and extends out of the housing 22. The battery 26 provides power to the PCBA 30 for controlling operation of the drive assembly 34. Specifically, the PCBA 30 controls rotation of the drive assembly 34. In some embodiments, the power tool 14 may not include the battery 26 such that the power tool 14 is connected to an external power source, and the external power source provides power to the PCBA 30 for controlling operation of the drive assembly 34. The chuck 38 is coupled to the drive assembly 34 for rotation with the drive assembly 34. The work light 42 (FIG. 1) is electrically connected to the PCBA 30 and is configured to illuminate a work area.

The housing 22 is tubular and includes a first end 22a and a second end 22b opposite the first end 22a. The housing 22 defines a plurality of inlet vents 44 at a location adjacent the battery 26 and the PCBA 30 and a plurality of outlet vents 46 at a location between the inlet vents 44 and the first end 22a of the housing 22. Although only one side of the housing 22 is illustrated with vents 44, 46, the housing 22 defines identical vents 44, 46 located opposite the illustrated vents 44, 46. The inlet vents 44 and the outlet vents 46 enable cooling of the battery 26, the PCBA 30, and the drive assembly 34, as will be described in further detail below. The chuck 38 extends through the first end 22a of the housing 22, and a cap portion 50 is positioned at the second end 22b of the housing 22. The cap portion 50 is removable from the housing 22 to enable insertion and removal of the battery 26 from the housing 22. The cap portion 50 includes a charge port 54 and an actuator 58. The charge port 54 enables the battery 26 to be charged without removal of the battery 26 from the housing 22. The actuator 58 is positioned adjacent the PCBA 30 and is actuatable to switch the power tool 14 between the on mode, in which a supply of power from the battery 26 is on, and the off mode, in which the supply of power from the battery 26 is off.

The battery 26 may be a power tool battery pack generally used to power a power tool 14, such as an electric drill, an electric screwdriver, and the like (e.g., a RYOBI USB Lithium 2.0 Ah rechargeable battery pack). The battery 26 may include lithium ion (Li-ion) cells. The battery 26 provides an optimal balance between weight/size and energy capacity in the illustrated power tool 14; however, batteries with other nominal energy capacities may be used in other embodiments.

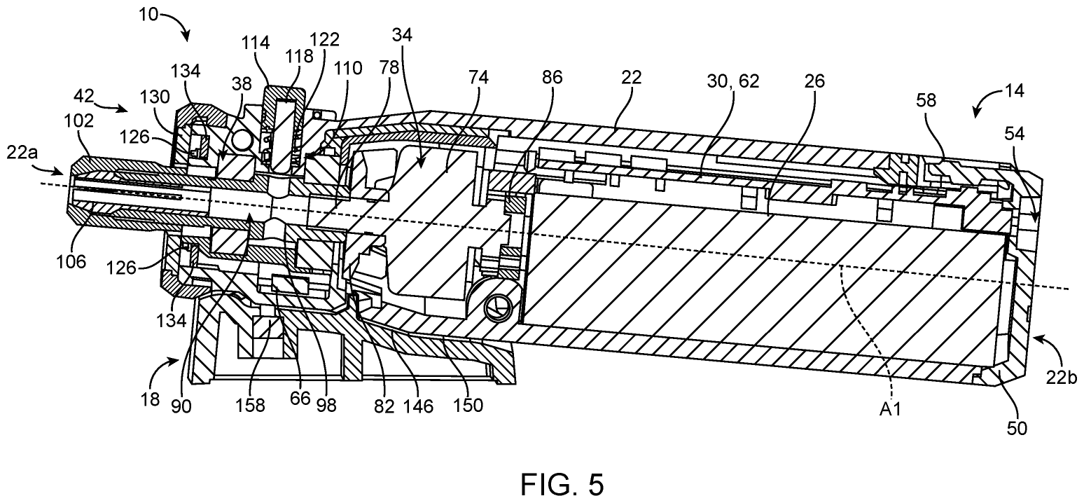

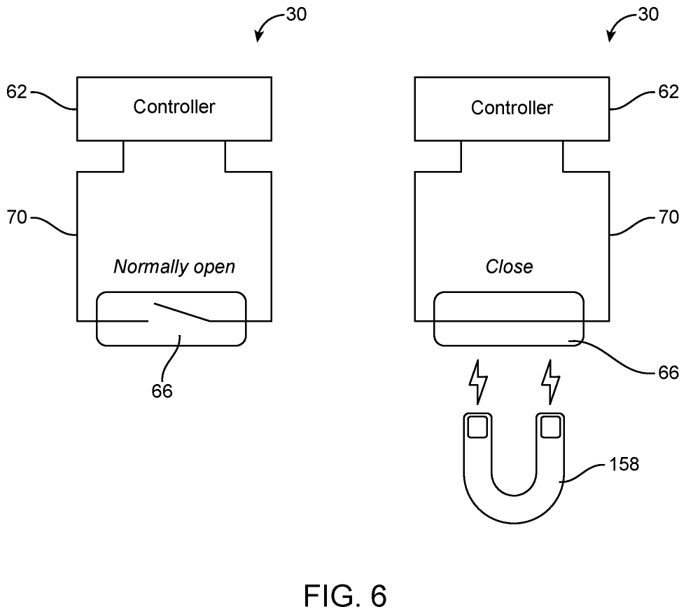

The PCBA 30 includes a main circuit board 62 and a reed switch 66. The main circuit board 62 is positioned within the housing 22 between an outer surface of the housing 22 and the battery 26. The main circuit board 62 extends in a direction parallel to a direction of extension of the battery 26. As such, the main circuit board 62 extends substantially along the battery 26. The reed switch 66 is positioned within the housing 22 between an outer surface of the housing 22 and the chuck 38. The reed switch 66 is electrically connected to the main circuit board 62 and is engageable to shut off a supply of power from the battery 26 to the drive assembly 34. That is, with reference to FIGS. 5 and 6, the reed switch 66 includes a switch circuit 70 that is electrically connected to the main circuit board 62 such that opening and closing the reed switch 66 is configured to selectively allow or block a supply of power from the battery 26. As such, the power tool 14 includes a second actuator for opening and closing the reed switch 66. In the illustrated embodiment, the second actuator is a magnet (e.g., magnet 158) such that a magnet force is used to close the reed switch 66 to block the supply of power from the battery 26. In other embodiments, the reed switch 66 may be closed through other means such as, but not limited to, a physically applied force. When the power tool 14 is in the on mode, the reed switch 66 is open, and the switch circuit 70 provides a path for power, or electricity, to flow from the battery 26 to the drive assembly 34. When a magnet force is applied to, or engaged with, the reed switch 66, the reed switch 66 closes and switches the power tool 14 to the standby mode. As such, when the power tool 14 is in the standby mode, the closed reed switch 66 blocks the path of power, or electricity, along the switch circuit 70 from the battery 26 to the drive assembly 34. Therefore, the power tool 14 is switchable to the standby mode without actuation of the actuator 58.

With reference to FIGS. 3 and 5, the drive assembly 34 includes a motor 74, an output shaft 78, a fan 82, and a motor support 86. The motor 74 is a brushless direct current (“BLDC”) motor 74. As such, the motor 74 may include a stator and a rotor. The motor 74 is positioned between the reed switch 66 and the actuator 58. That is, the reed switch 66 is positioned between the first end 22a of the housing 22 and the motor 74, and the actuator 58 is positioned between the motor 74 and the second end 22b of the housing 22. When the power tool 14 is in the on mode, the motor 74 drives rotation of the output shaft 78 about an output axis A1. When the power tool 14 is in the off mode, the motor 74 may be stationary relative to the housing 22. When the power tool 14 is in the standby mode, rotation of the motor 74 is stopped. The fan 82 is mounted to the output shaft 78 for rotation with the output shaft 78 and is positioned on a side of the motor 74 opposite from the battery 26 and the PCBA 30. With reference to FIGS. 2 and 3, during operation of the power tool 14, the fan 82 induces air flow into the plurality of inlet vents 44 and exhausts the air flow out of the plurality of outlet vents 46, which are located radially outward of the fan 82. As such, the air flow travels past and cools the battery 26, the PCBA 30, and the motor 74. The motor support 86 is positioned between the motor 74 and the battery 26 and supports a portion of the output shaft 78. The motor support 86 is coupled to the housing 22 with a fastener such that the motor support 86 is inhibited from moving relative to the housing 22. As such, the motor support 86 inhibits translational movement of the motor 74 and the output shaft 78 relative to the housing 22.

With reference to FIGS. 3 and 5, the chuck 38 is positioned on a side of the fan 82 opposite from the motor 74. The chuck 38 is mounted to the output shaft 78 for rotation with the output shaft 78. The chuck 38 is at least partially positioned within the housing 22 and extends through the first end 22a of the housing 22 to a position external of the housing 22. The chuck 38 defines a receptacle 90 for receiving a tool bit 94 and includes a chuck spindle 98, a collar 102, a collet 106, and a detent mechanism 110. The chuck spindle 98 is mounted to the output shaft 78. The collar 102 is mounted to the chuck spindle 98. The collar 102 is rotatable relative to the chuck spindle 98 to open and close the collet 106 around the tool bit 94 for selectively retaining the tool bit 94 within the chuck 38. In some embodiments, a tool accessory, such as a wrench, may be used to rotate the collar 102. In other embodiments, the collar 102 may be tool-les sly rotated. The detent mechanism 110 is movable into the chuck spindle 98 to prevent rotation of the chuck spindle 98 and the output shaft 78 as the collar 102 is rotated to open and close the collet 106. Specifically, the detent mechanism 110 includes a button 114, a retention rod 118, and a spring 122. The button 114 protrudes from the housing 22. The retention rod 118 extends from the button 114 toward the chuck spindle 98. The spring 122 has an end positioned at the button 114 and an end positioned at the chuck spindle 98. As such, the spring 122 biases the button 114 away from the chuck spindle 98. The button 114 is pressable against the bias of the spring 122 to move the retention rod 118 into the chuck spindle 98 for inhibiting rotation of the chuck spindle 98 and the output shaft 78 relative to the collar 102.

With continued reference to FIGS. 3 and 5, the work light 42 includes a plurality of LED units 126 positioned circumferentially around the chuck 38 and a lens 130 positioned adjacent to the plurality of LED units 126. Specifically, the lens 130 is positioned in front of the plurality of LED units 126 in a direction extending along the output axis A1. The plurality of LED units 126 is mounted to a work light circuit board 134 that is electrically connected to the PCBA 30. When the power tool 14 is in the on mode, the lens 130 is configured to focus light emitted from the plurality of LED units 126 onto a work area. When the power tool 14 is in the off mode, the work light 42 is turned off and does not illuminate a work area. When the power tool 14 is in the standby mode, the plurality of LED units 126 flash, or blink, intermittently and may provide an indication that the power tool 14 is in the standby mode rather than the off mode. In other embodiments, the work light 42 may shut off in the standby mode.

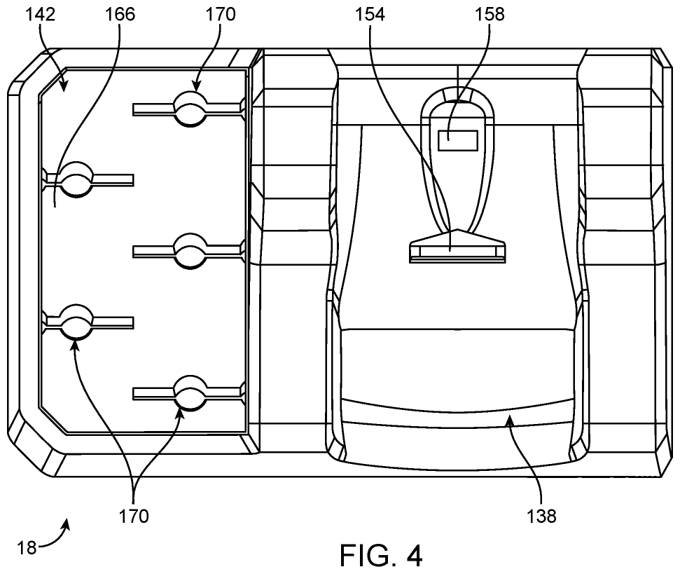

As illustrated in FIGS. 4 and 5, the base 18 includes a pocket 138 and a bit storage portion 142. The pocket 138 is complimentarily shaped to receive the power tool 14. That is, a pocket surface 146 is complimentarily shaped to a housing surface 150 of the power tool 14. The pocket 138 includes a coupling projection 154 and a magnet 158. When the power tool 14 is aligned in the pocket 138, the coupling projection 154 extends through a slot 162 in the housing 22 of the power tool 14 to engage power tool 14 and to inhibit the power tool 14 from inadvertently, or unintentionally, being removed from the pocket 138. The magnet 158 is positioned adjacent to the coupling projection 154 and is recessed relative to the pocket surface 146.

With reference to FIGS. 5 and 6, the magnet 158 is configured engage the reed switch 66 to close the reed switch 66, thereby switching the power tool 14 to the standby mode. In the illustrated embodiment, the magnetic field of the magnet 158 may communicate or otherwise engage the reed switch 66 when the power tool 14 is a predetermined distance from the base 18 (corresponding to a predetermined distance between the reed switch 66 and the second actuator, for example, the magnet 158) to close the reed switch 66 and, as a result, stop rotation of the motor 74. The predetermined distance may be a non-zero distance (e.g., 0.2 inches, 0.5 inches, 1 inch, 2 inches) based on the strength of the magnetic field of the magnet 158, or the predetermined distance may be approximately zero (e.g., when the power tool 14 is placed on or substantially placed on the base 18).

The bit storage portion 142 is substantially rectangular and includes a foam storage insert 166. The foam storage insert 166 defines a plurality of bit storage apertures 170 that may receive a plurality of tool bits 94a-94e in a vertical or upright position (e.g., as illustrated in FIG. 1). The plurality of tool bits 94a-94e may include, for example, drill bits 94a-94c, drive bits, and die grinder bits 94d, 94e. As described above, each of the plurality of tool bits 94a-94e may be inserted and removed from the chuck 38 for performing various working operations.

In some embodiments, the base 18 may be couplable, or attachable, to the power tool 14. That is, the power tool 14 and the base 18 may be coupled together without placing the power tool 14 in the pocket 138. For example, the power tool 14 may include magnets that interact with the magnet 158 in the base 18 to couple the power tool 14 and the base 18 together. In such embodiments, the base 18 may be movable with the power tool 14 without holding the base 18 and the power tool 14 together.

In operation of the power tool 14, the tool bit 94 may be inserted into the chuck 38 to perform a work operation by opening the collar 102 and the collet 106. With the tool bit 94 inserted into the receptacle 90 of the chuck 38, the collar 102 may be rotated to close the collet 106 around the tool bit 94, thereby securing the tool bit 94 within the chuck 38. With the tool bit 94 secured in the chuck 38, the actuator 58 may be actuated to switch the power tool 14 to the on mode such that the battery 26 begins providing power to the PCBA 30 and the drive assembly 34. With power supplied to the drive assembly 34, the motor 74 begins to drive rotation of the chuck 38 and the tool bit 94 via the output shaft 78 such that a work operation may be performed.

It may be desirable to temporarily set down the power tool 14 (e.g., to make adjustments to the work piece or to perform other short-term tasks). The power tool 14 may be positioned in alignment or in engagement with the pocket 138 of the base 18 (within the predetermined distance) so that the magnet 158 may engage and close the reed switch 66 to stop rotation of the motor 74 and the chuck 38 and switch the power tool 14 to the standby mode. Alignment of the power tool 14 with the base 18 means direct engagement of the power tool 14 with the base 18, or positioning the power tool 14 within a short distance (the predetermined distance) of the base 18. When the power tool 14 is placed in the pocket 138, the coupling projection 154 extends into the slot 162 to inhibit the power tool 14 from being inadvertently, or unintentionally, removed from the pocket 138. To resume the work operation, the power tool 14 may be lifted out of the pocket 138. After the power tool 14 is moved from the base 18 beyond the predetermined distance (e.g., disengaged from the base 18, or moved farther than the predetermined distance), the reed switch 66 automatically opens and the power supply from the battery 26 to the drive assembly 34 may resume to rotate the motor 74 (and the chuck 38). After the work operation is complete, the actuator 58 may be pressed to switch the power tool 14 to the off mode.

As described above, some or all illustrated features may be omitted in a particular implementation within the scope of the present disclosure, and some illustrated features may not be required for implementation of all embodiments. The features described above may be implemented in an order different from the order described above and does not prohibit implementation in another order or combination. While not explained in detail for each embodiment and/or construction, the features of the disclosure described herein may be included on the power tool and the base independent of other features and are not limited to the illustrated disclosure. Embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

Although the invention has been described with reference to certain embodiments, variations and modifications exist within the scope and spirit of the one or more independent aspects of the invention described. Various features of the invention are set forth in the following claims.

1. A power tool system comprising:
a power tool including
a housing supporting or connected to a power source;
a motor supported by and disposed in the housing and including an output shaft, the motor configured to drive rotation of the output shaft; and
a chuck coupled to the output shaft for rotation with output shaft, the chuck configured to receive a tool bit configured to perform an operation; and
a base engageable by the power tool,
wherein alignment of the power tool and the base is configured to stop rotation of the chuck.

2. The power tool system of claim 1, wherein the base includes a pocket and the housing is shaped to fit into the pocket, and wherein rotation of the chuck is stopped when the power tool is engaged with the base within the pocket.

3. The power tool system of claim 2, wherein the base includes a projection defining a portion of the pocket, and wherein the projection extends into the housing on engagement of the power tool with the base.

4. The power tool system of claim 1, wherein rotation of the chuck is stopped when the power tool is attached to the base.

5. The power tool system claim 1, wherein alignment of the power tool with the base includes positioning the power tool within a predetermined distance relative to the base.

6. The power tool system of claim 5, wherein the predetermined distance is greater than zero and less than 1 inch.

7. The power tool system of claim 1, wherein the power tool further includes a work light positioned adjacent to the chuck and configured to illuminate during rotation of the output shaft, and wherein, on alignment of the power tool and the base, the work light is configured to flash.

8. The power tool system of claim 1, wherein one of the power tool and the base includes a switch and the other of the power tool and the base includes a magnet, and wherein alignment between the power tool and the base includes placement of the switch within a predetermined distance of the magnet to stop rotation of the chuck.

9. The power tool system of claim 1, wherein the base includes a tool bit storage section configured to hold a plurality of tool bits compatible for use with the power tool.

10. A power tool comprising:
a housing supporting or connected to a power source;
a motor supported by and disposed in the housing and including an output shaft, the motor configured to drive rotation of the output shaft;
an actuator disposed on the housing and actuatable to switch the power tool between an on mode in which the motor is configured to rotate the output shaft, and an off mode in which the motor does not rotate and the power tool is powered down; and
a chuck coupled to the output shaft for rotation with the output shaft, the chuck configured to receive a tool bit configured to perform a work operation;
wherein the power tool is manipulatable between the on mode and a standby mode in which rotation of the motor is stopped without actuation of the actuator.

11. The power tool of claim 10, wherein the actuator is a first actuator and the power tool further includes a switch configured to vary the power tool to the standby mode in response to placement of the switch within a predetermined distance of a second actuator.

12. The power tool of claim 11, wherein the switch includes a reed switch.

13. The power tool of claim 11, wherein the power tool is configured to engage a base including the second actuator to switch the power tool to the stand-by mode.

14. The power tool of claim 11, wherein the switch and the actuator are positioned on opposite sides of the housing.

15. The power tool of claim 10, further comprising a work light disposed adjacent to the chuck and configured to illuminate when the power tool is in the on mode, wherein the work light does not illuminate when the power tool is in the off mode, and wherein the work light flashes intermittently when the power tool is in the stand-by mode.

16. A power tool system comprising
a power tool including
a housing supporting or connected to a power source,
a first component supported by and disposed in the housing,
a motor supported by and disposed in the housing and including an output shaft, the motor configured to drive rotation of the output shaft, and
a chuck coupled to the output shaft for rotation with the output shaft, the chuck configured to receive a tool bit configured to perform a work operation; and
a base including a second component that is configured to align with the first component to stop rotation of the motor.

17. The power tool system of claim 16, wherein the first component is one of a reed switch and a magnet, and wherein the second component is the other of the reed switch and the magnet.

18. The power tool system of claim 16, wherein the base includes a pocket and the housing is shaped to fit into the pocket, and wherein the second component is recessed from a surface of the pocket.

19. The power tool system of claim 18, wherein the first component is positioned between a surface of the housing and the chuck, and wherein alignment of the first component and the second component includes positioning the first component and the second component a non-zero distance from each other.

20. The power tool system of claim 18, wherein the first component and the second component are configured to engage each other when the power tool is positioned in the pocket.
